(19) United States
(12) Patent Application Publication
(10) Pub. No.: US 2004/0249681 A1
(43) Pub. Date: Dec. 9, 2004

(54) Software program and method for facilitating a purchase over a global information network

(75) Inventors: Roy William Staten, Scottsdale, AZ (US); William B. Friday, Goodyear, AZ (US); Benjamin Andrew Krueger, Mesa, AZ (US); G. Matthew Johnson, Scottsdale, AZ (US)

Correspondence Address: Kenneth A. Nelson, Bryan Cave LLP, Suite 2200, Two North Central Avenue, Phoenix, AZ, 85004-4406, US

(73) Assignee: Aaron Corporation

(21) Appl. No.: 10/456,762

(22) Filed: Jun. 6, 2003

(51) Int. Cl. G06F 17/60

(52) U.S. Cl. 705/5

(57) ABSTRACT

A method of facilitating a purchase over a global information network includes: providing information regarding a first and second plurality of destinations on a web site; receiving selections and transmitting information regarding a first one of the first plurality of destinations via the global information network; transmitting information and receiving selections regarding the second plurality of destinations via the global information network; and permitting simultaneous purchasing of reservations for the first and second plurality of destinations based on the selections.

### FIELD OF THE INVENTION

This invention relates generally to a global information network, and relates more particularly to reservations purchased over a global information network.

### BACKGROUND OF THE INVENTION

A person desiring to purchase a reservation at a destination may choose from among a variety of options for doing so. One such option is to use a computer or similar device to access information about, and to communicate with, the destination via a global information network such as the Internet. Conventionally, when a reservation is purchased via the Internet in this fashion, the person desiring to purchase the reservation, which person is also referred to herein as a user, must make various selections regarding the destination and must also provide billing information. The billing information required typically includes at least a credit card number and a billing address.

Quite often, the user desires to purchase reservations at multiple destinations, such as when the user desires to reserve both a tee time at a golf course and a room at a hotel, or both a room at a hotel and an entrance ticket to an amusement park. If the user is unfamiliar with the city, region, or locale in which the destinations are located, determining acceptable destinations, such as those that are within an acceptable distance from each other, may be difficult. Additionally, the user must provide billing information each time a reservation is purchased. Providing billing information multiple times can be tedious and time consuming for the user. Accordingly, a need exists for a method of purchasing reservations over a global information network, where the method is capable of providing assistance to the user in terms of determining acceptable destinations and does not require the user to enter billing information multiple times.

### BRIEF DESCRIPTION OF THE DRAWINGS

The invention will be better understood from a reading of the following detailed description, taken in conjunction with the accompanying figures in the drawings in which:

FIG. 1 is an illustration of a screen display generated by or in connection with at least two subroutines of a software program for facilitating a purchase over a global information network according to an embodiment of the invention;

FIG. 2 is an illustration of a screen display showing an example of an arrangement of information that may be displayed for the user according to an embodiment of the invention;

FIG. 3 is an illustration of a screen display generated by or in connection with a subroutine of the software program according to an embodiment of the invention;

FIG. 4 is an illustration of a screen display generated by or in connection with a plurality of subroutines of the software program according to an embodiment of the invention;

FIG. 5 is an illustration of a screen display generated by or in connection with a subroutine of the software program according to an embodiment of the invention;

FIG. 6 is an illustration of a screen display generated by or in connection with a plurality of subroutines of the software program according to an embodiment of the invention;

FIG. 7 is an illustration of a screen display generated by or in connection with a plurality of subroutines of the software program according to an embodiment of the invention;

FIG. 8 is an illustration of a screen display generated by or in connection with a plurality of subroutines of the software program according to an embodiment of the invention;

FIG. 9 is an illustration of a screen display generated by or in connection with a plurality of subroutines of the software program according to an embodiment of the invention;

FIG. 10 is an illustration of a screen display generated by or in connection with a plurality of subroutines of the software program according to an embodiment of the invention;

FIG. 11 is an illustration of a screen display generated by or in connection with a subroutine of the software program according to an embodiment of the invention;

FIG. 12 is an illustration of a screen display generated by or in connection with a subroutine of the software program according to an embodiment of the invention;

FIG. 13 is an illustration of another screen display according to an embodiment of the invention;

FIG. 14 is an illustration of another screen display according to an embodiment of the invention;

FIG. 15 is an illustration of another screen display according to an embodiment of the invention;

FIG. 16 is an illustration of another screen display according to an embodiment of the invention;

FIG. 17 is an illustration of another screen display according to an embodiment of the invention;

FIG. 18 is an illustration of another screen display according to an embodiment of the invention;

FIG. 19 is an illustration of another screen display according to an embodiment of the invention;

FIG. 20 is an illustration of another screen display according to an embodiment of the invention;

FIG. 21 is an illustration of another screen display according to an embodiment of the invention;

FIG. 22 is an illustration of another screen display according to an embodiment of the invention;

FIG. 23 is an illustration of another screen display according to an embodiment of the invention;

FIG. 24 is a flow chart illustrating a method of facilitating a purchase over a global information network according to an embodiment of the invention;

FIG. 25 is a flow chart illustrating a continuation of the method of facilitating a purchase over a global information network described in FIG. 24 according to an embodiment of the invention;

FIG. 26 is a block diagram of a system for facilitating a purchase over a global information network according to an embodiment of the invention;

FIG. 27 is a block diagram of another system for facilitating a purchase over a global information network; and

FIG. 28 is a block diagram of another system for facilitating a purchase over a global information network.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner.

### DETAILED DESCRIPTION OF THE DRAWINGS

In one embodiment of the invention, a method of facilitating a purchase over a global information network comprises: providing information regarding a first plurality of destinations on a web site; providing information regarding a second plurality of destinations on the web site; receiving a first selection regarding a first one of the first plurality of destinations via the global information network; transmitting information regarding the first selection via the global information network; based on the first selection, transmitting information regarding only a portion of the second plurality of destinations via the global information network; after transmitting the information regarding the portion of the second plurality of destinations, receiving a second selection regarding a first one of the portion of the second plurality of destinations via the global information network; transmitting information regarding the second selection via the global information network; and permitting simultaneous purchasing of reservations for the first and second plurality of destinations based on the first and second selections.

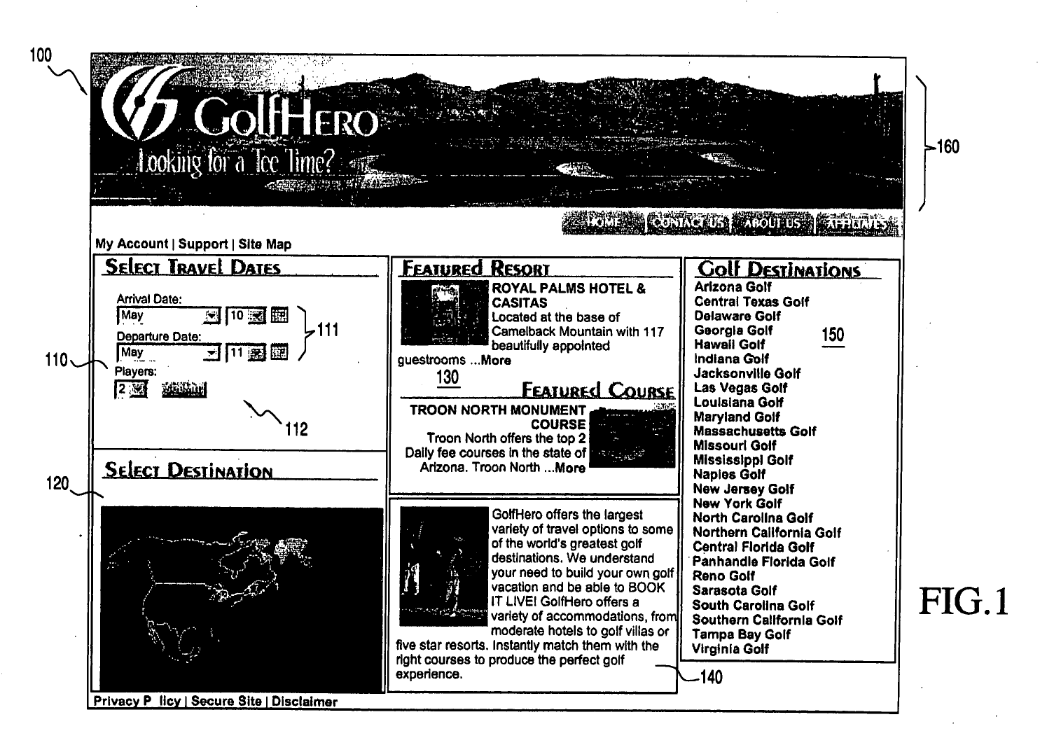

Referring now to the figures, FIG. 1 is an illustration of a screen display 100 generated by or in connection with at least two subroutines of a software program for facilitating a purchase over a global information network according to an embodiment of the invention. The first subroutine is capable of providing information regarding a first plurality of destinations, and the second subroutine is capable of providing information regarding a second plurality of destinations on a web site. The software program of which the first and second subroutines are a part may be embodied on a memory, computer readable medium, or other data storage device and may run on a computer located at the destination or at another location, such as the location of another entity hired by or otherwise associated with the destination. This other entity could be an entity handling one or more aspects of the reservation process for one or more destinations, and will be referred to herein as a reservation facilitator. A memory, computer readable medium, or other data storage device that is part of, coupled to, or associated with the computer may contain data and information needed to operate the software program.

Screen display 100 comprises block~s 110, 120, 130, 140, 150, and 160, and may be a home page of the web site. Block 110 comprises fields 111 that allow a person desiring to purchase a reservation at a destination to select a date on which the reservation is desired. Such a person will be referred to herein both as a “user” and, where needed for purposes of clarity, as a “visitor to the web site.” In one embodiment, selecting a date in fields 111 obviates the need to select the date again on or in connection with subsequently-described screen displays. Selecting the date in fields 111, however, need not preclude a user from changing the date, if desired, on or in connection with subsequently-described screen displays. As it is used herein, the term “destination” means a facility for which reservations may be purchased, such as a golf course, a hotel, an amusement park, a restaurant, a movie theater, or the like. Block 110 further comprises fields 112 that allows the user to indicate a number of people to which the reservation applies.

Block 120 allows the user to select a geographical location. As an example, the user may have a particular destination in mind, in which case the user may select the geographical location in which the destination lies and, in a subsequently described step, select the particular destination. As another example, the user may desire to travel to a particular geographical location but be unsure about which destination or destinations to visit while in the geographical location, in which case the user may select the geographical location of choice and subsequently decide which destinations to visit therein. A database containing information regarding the first and/or second pluralities of destinations may contain geocode information in the form of global positioning system (GPS) data for some or all of the destinations in the database. As will be described in more detail below, a user may select destinations based on this GPS data.

Block 130 contains information about featured destinations. As an example, a particular destination may arrange to place an advertisement in block 130. As another example, a particularly popular destination may be profiled in block 130. Block 140 contains information about the software program, an entity offering, maintaining, selling, running, or otherwise associated with the software program, or the like. Block 150 lists a plurality of geographical locations within which are located destinations for which reservations may be purchased by the visitor to the web site. Block 160 comprises a header that may contain graphical and/or textual information. The header depicted in block 160 may be a generic header, such as a picture of an unspecified golf course, or the header may be customized such that it is specific to a particular destination.

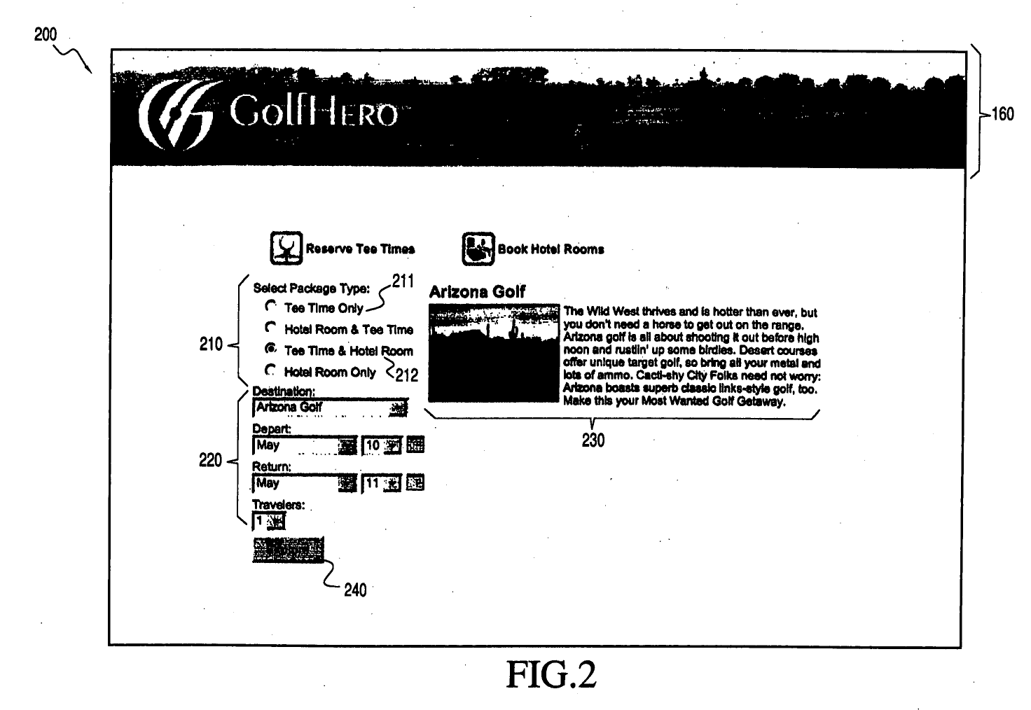

FIG. 2 is an illustration of a screen display 200 showing an example of an arrangement of information that may be displayed for the user according to an embodiment of the invention. As an example, the information may be displayed for the user following the user's selection of a geographical location, such as may be made using block 120 and/or 150 in FIG. 1. Screen display 200 comprises blocks 160, 210, 220, and 230 as well as a field 240. In the illustrated example, the first and second pluralities of destinations are golf courses and hotels, but it will be understood that the first and second pluralities of destinations could, in other embodiments, comprise different kinds of destinations, such as movie theaters, amusement parks, restaurants, and the like. It will be further understood that, in at least one embodiment of the invention, reservations may be purchased for more than two destinations chosen from among the first and/or second pluralities of destinations and/or some other group of destinations.

Block 210 of screen display 200 allows the user to select a grouping pertaining to the first and second pluralities of destinations. As an example, in a field 211 of block 210 the user could choose to be given the opportunity, in a subsequent step, to purchase a reservation at one of the first plurality of destinations—for example, a tee time at a golf course—without also purchasing a reservation at one of a second plurality of destinations. As another example, in a field 212 of block 210 the user could choose to be given the opportunity, in a subsequent step, to purchase reservations both at one of a first plurality of destinations and at one of a second plurality of destinations.

Block 220 of screen display 200 contains information and allows selections regarding certain details regarding the purchase of the reservation or reservations. As an example, block 220 could contain information and allow selections regarding a geographical location where the reservations are to be purchased, a date or range of dates for which the reservations are desired, and a number of people to which the reservations pertain.

Block 230 of screen display 200 contains information regarding the geographical location where the reservations are to be purchased. The geographical location to which the information in block 230 pertains can be the geographical location selected in block 120 and/or 150 of FIG. 1, block 220 of FIG. 2, or some other geographical location. Field 240 of screen display 200 allows the user to enter the selections made in blocks 210 and 220, thus causing the selections to be transmitted via the global information network to the reservation facilitator.

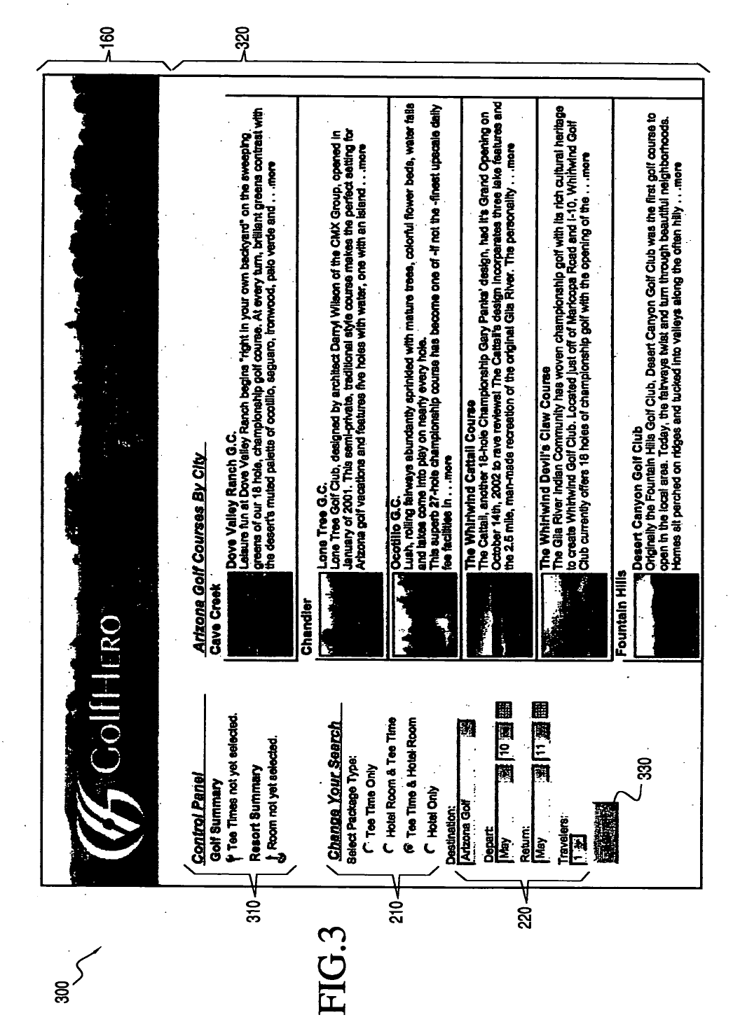

FIG. 3 is an illustration of a screen display 300 generated by or in connection with a subroutine of the software program according to an embodiment of the invention. Screen display 300 comprises blocks 160, 210, 220, 310, and 320. Block 220 further comprises a field 330. Block 310 contains information about reservations selected but not yet purchased or finalized. In the embodiment illustrated in FIG. 3, block 310 shows that no such reservations have yet been selected. Block 320 contains information regarding a first plurality of destinations located within the geographical location selected by the user. As an example, the first plurality of destinations can be a plurality of golf courses, a plurality of hotels, a plurality of restaurants, or the like. In the illustrated embodiment, block 320 contains both graphical and textual information regarding the first plurality of destinations. Following the selection of a first one of the first plurality of destinations in block 320, the user may press, click, or otherwise manipulate field 330, thus causing the selection to be transmitted via the global information network to the reservation facilitator. In one embodiment of the invention, more than one of the first plurality of destinations may be selected.

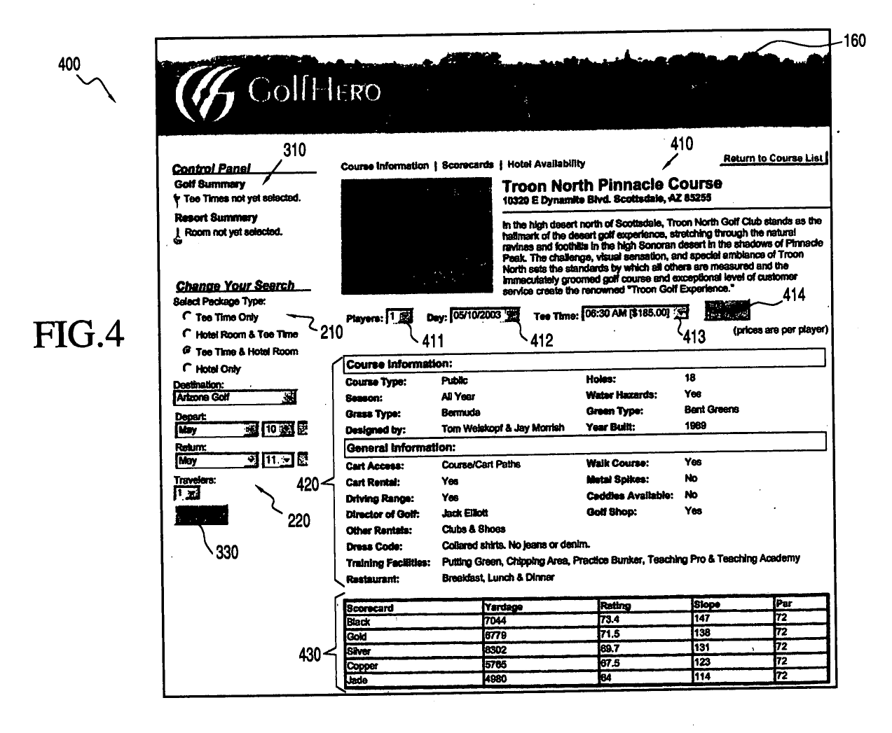

FIG. 4 is an illustration of a screen display 400 generated by or in connection with a plurality of subroutines of the software program according to an embodiment of the invention. Screen display 400 comprises blocks 160, 210, 220, 310, 410, 420, and 430. Block 410 contains information regarding the first one of the first plurality of destinations. In the illustrated embodiment, block 410 contains both graphical and textual information regarding the first one of the first plurality of destinations. Block 410 further comprises fields 411, 412, 413, and 414. Field 411 allows the user to select a number of players to which the reservation at the first one of the first plurality of destinations pertains. Fields 412 and 413 allow the user to select a date and time, respectively, for the reservation. In the illustrated embodiment, the time for the reservation is a tee time for a round of golf at the first one of the first plurality of destinations. In one embodiment of the invention, more than one tee time may be selected. It will be understood that the time for the reservation, e.g., the tee time, includes both a date and a time of day. Field 414 allows the user to transmit the selections made in fields 411, 412, and 413 via the global information network to the reservation facilitator, by pressing, clicking, or otherwise manipulating field 414.

Blocks 420 and 430 contain further information regarding the first one of the first plurality of destinations. As an example, where the first one of the first plurality of destinations is a golf course, block 420 can contain information regarding a course type, a grass type, a year built, a designer's name, cart access, a dress code, training facilities, and the like. As a further example, block 430 can contain information regarding a scorecard for the first one of the first plurality of destinations.

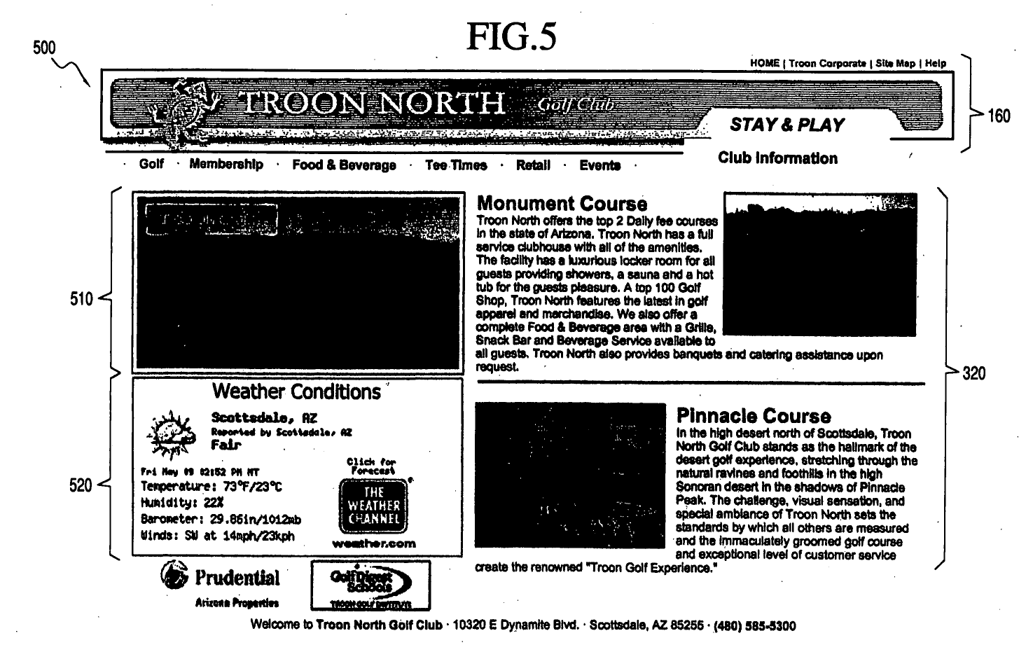

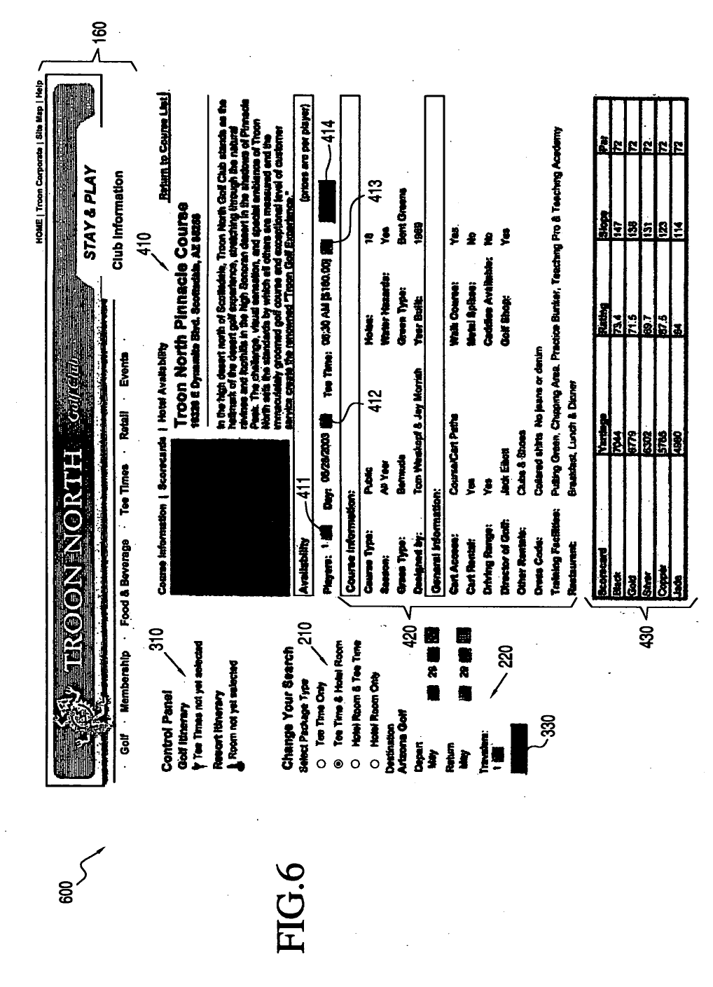

FIG. 5 is an illustration of a screen display 500 generated by or in connection with a subroutine of the software program according to an embodiment of the invention. Screen display 500 is an example of a screen display customized for an operator of a particular one or ones of the first plurality of destinations (the “operator”). Screen display 500 comprises blocks 160, 320, 510, and 520. Instead of containing a generic header, block 160 is customized such that it is specific to a particular group of destinations. In the illustrated embodiment, block 160 contains a header customized for Troon North Golf Club. FIGS. 6-12, in addition to FIG. 5, contain a header customized for Troon North Golf Club in blocks 160.

It was mentioned above that block 320 contains information regarding a first plurality of destinations located within the geographical location selected by the user. In the customized embodiment illustrated in FIG. 5, block 320 contains filtered information regarding only those destinations chosen by the operator. As an example, block 320 could contain filtered information regarding only those destinations owned and/or operated by the operator. As another example, block 320 could contain filtered information regarding both those destinations owned and/or operated by the operator and those destinations that the operator has agreed to promote and/or advertise, perhaps as part of a cross-marketing relationship.

FIG. 6 is an illustration of a screen display 600 generated by or in connection with a plurality of subroutines of the software program according to an embodiment of the invention. Screen display 600 is similar to screen display 400 in FIG. 4, and includes the header, discussed above, customized for Troon North Golf Club.

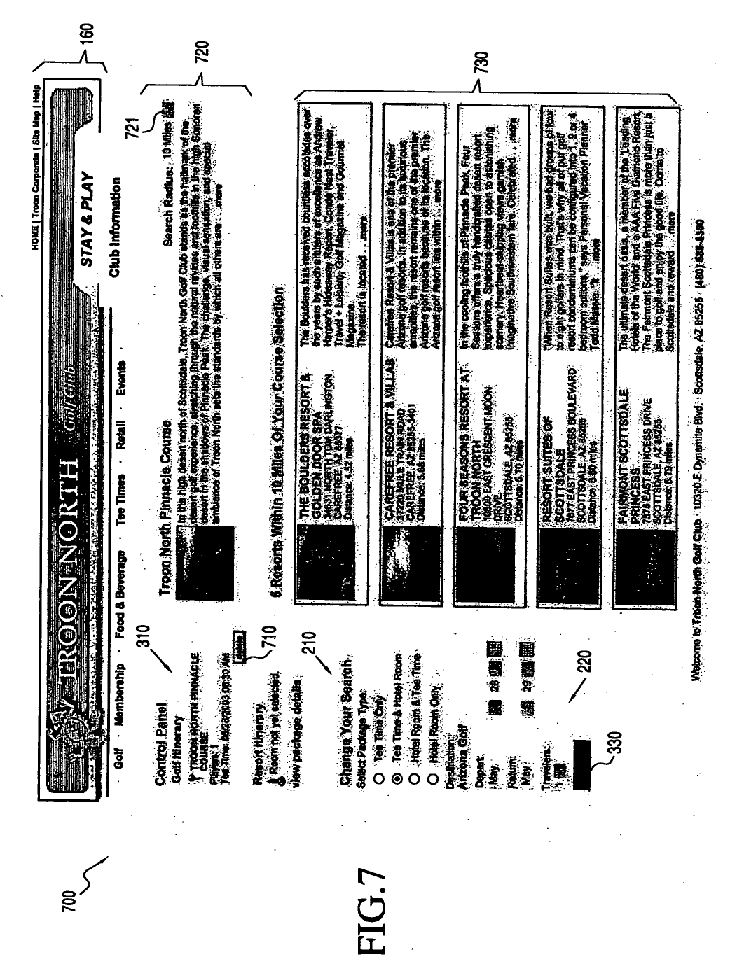

FIG. 7 is an illustration of a screen display 700 generated by or in connection with a plurality of subroutines of the software program according to an embodiment of the invention. Screen display 700 comprises blocks 160, 210, 220, 310, 720, and 730. Screen display 700 further comprises a field 710 in block 310. Field 710 is not a part of block 310 of screen display 600 in FIG. 6. In FIG. 7, block 310 contains information about a reservation for the first one of the first plurality of destinations that has been selected but not yet purchased or finalized. Field 710 allows the user to delete the reservation for the first one of the first plurality of destinations, by pressing, clicking, or otherwise manipulating field 710.

Block 720 of screen display 700 contains information regarding the first one of the first plurality of destinations. As an example, the information contained in block 720 can be similar to the information contained in block 410 in FIGS. 4 and 6. Block 720 comprises a field 721 that allows the user to make a selection that allows the software program to assist the user in determining which destinations will be acceptable to the user. As an example, field 721 can allow the user to select a particular distance within which each one of the second plurality of destinations are to be located with respect to the first one of the first plurality of destinations displayed in block 720. As a particular example, the particular distances displayed in field 721 and from among which the user can choose can be five-mile increments between five and 50 miles. Smaller or larger increments, as well as smaller or larger limits on both ends of the range, could also be used. As another example, field 721 can allow the user to select desired amenities, a quality level (e.g., four-star, five-star, etc.), a cost range, or the like at each one of the second plurality of destinations.

Block 730 contains graphical and/or textual information regarding a portion of the second plurality of destinations. As an example, the portion of the second plurality of destinations can comprise those particular destinations of the second plurality of destinations that are located within the particular distance, selected using field 721 of block 720, of the first one of the first plurality of destinations. The number and identity of the particular destinations of the second plurality of destinations contained in block 730 depend on the selection entered in field 721.

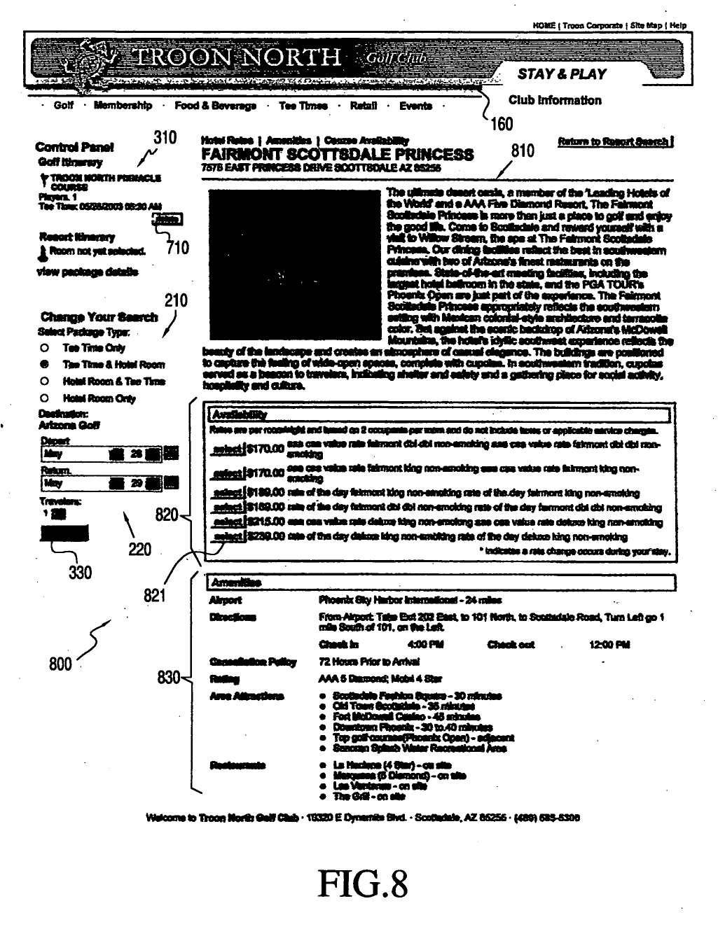

FIG. 8 is an illustration of a screen display 800 generated by or in connection with a plurality of subroutines of the software program according to an embodiment of the invention. Screen display 800 comprises blocks 160, 210, 220, 310, 810, 820, and 830. Block 810 of screen display 800 contains information regarding a first one of the second plurality of destinations. In the illustrated embodiment block 810 contains both graphical and textual information regarding the first one of the second plurality of destinations, and the first one of the second plurality of destinations is a hotel. In one embodiment of the invention, more than one of the second plurality of destinations may be selected.

Block 820 of screen display 800 contains information regarding available rooms at the first one of the second plurality of destinations. As an example, the information contained in block 820 can include information regarding a price of a room, a type of and/or a number of beds in a room, a smoking or non-smoking status of a room, and the like. Block 820 comprises fields 821 that allow the user to select a particular one of the available rooms by pressing, clicking, or otherwise manipulating fields 821. In one embodiment of the invention, more than one of the available rooms may be selected. Block 830 of screen display 800 contains further information regarding the first one of the second plurality of destinations. As an example, the information contained in block 830 can include information regarding a nearby airport, driving directions to the first one of the second plurality of destinations from the airport, a check-in and a check-out time, a cancellation policy, a rating, area attractions, nearby restaurants, and the like.

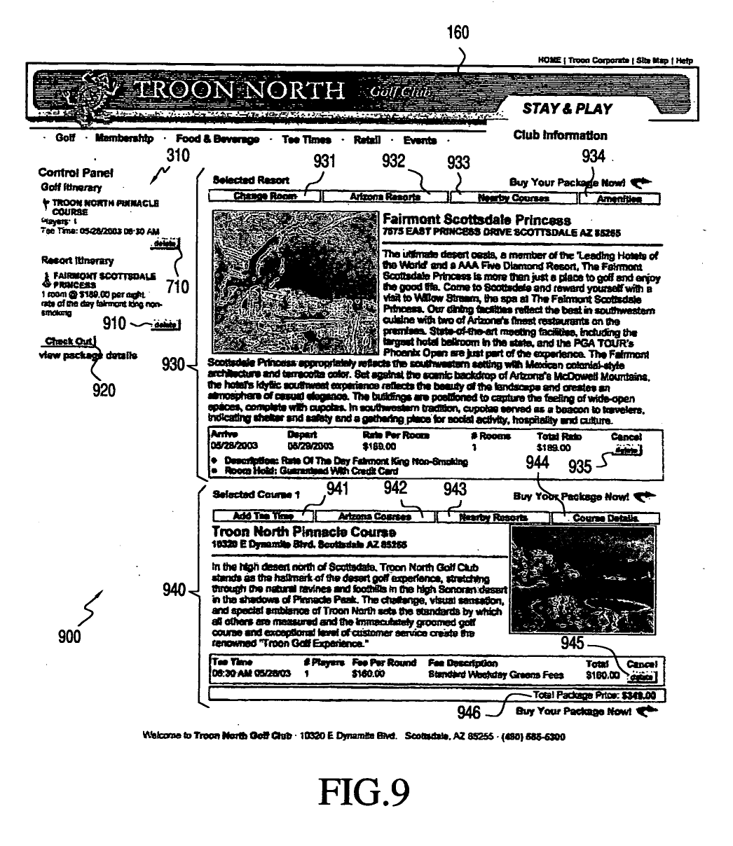

FIG. 9 is an illustration of a screen display 900 generated by or in connection with a plurality of subroutines of the software program according to an embodiment of the invention. Screen display 900 comprises blocks 160, 310, 930, and 940. Block 310 of screen display 900 comprises fields 910 and 920. In FIG. 9, block 310 contains information about a reservation for the first one of the second plurality of destinations that has been selected but not yet purchased or finalized. Field 910 allows the user to delete the reservation for the first one of the second plurality of destinations, by pressing, clicking, or otherwise manipulating field 910. Field 920 allows the user to begin the check-out process, or in other words to begin finalizing the purchase of the reservations, by pressing, clicking, or otherwise manipulating field 920.

Block 930 contains information regarding the first one of the second plurality of destinations. The information contained in block 930 can be graphical and/or textual in nature. At least a portion of the information contained in block 930 can be similar to at least a portion of the information contained in block 810 in FIG. 8. Block 930 comprises fields 931, 932, 933, 934, and 935. Field 931 allows the user to select a different one of the available rooms, by pressing, clicking, or otherwise manipulating field 931. Field 932 allows the user to view information regarding at least a portion of the second plurality of destinations, by pressing, clicking, or otherwise manipulating field 932. Field 933 allows the user to view information regarding a portion of the first plurality of destinations, by pressing, clicking, or otherwise manipulating field 933. As an example, the portion of the first plurality of destinations can be the portion within the maximum distance from the first one of the second plurality of destinations, which maximum distance was selected by the user in connection with field 721 in FIG. 7. Field 934 of block 930 allows the user to view particular information regarding the first one of the second plurality of destinations, by pressing, clicking, or otherwise manipulating field 934. As an example, the information contained in field 934 can be similar to the information contained in block 830 in FIG. 8. Field 935 of block 930 can perform a function similar to field 910 of block 310, and allows the user to delete the reservation for the first one of the second plurality of destinations, by pressing, clicking, or otherwise manipulating field 935.

Block 940 contains information regarding the first one of the first plurality of destinations. The information contained in block 940 can be graphical and/or textual in nature. At least a portion of the information contained in block 940 can be similar to at least a portion of the information contained in block 410 in FIGS. 4 and 6, and block 720 in FIG. 7. Block 940 comprises fields 941, 942, 943, 944, 945, and 946. Field 941 allows the user to select an additional tee time for subsequent purchase, by pressing, clicking, or otherwise manipulating field 941. Field 942 allows the user to view information regarding at least a portion of the second plurality of destinations, by pressing, clicking, or otherwise manipulating field 942. Field 943 allows the user to view information regarding a portion of the second plurality of destinations, by pressing, clicking, or otherwise manipulating field 933. As an example, the portion of the second plurality of destinations can be the portion within the maximum distance from the first one of the first plurality of destinations selected by the user in connection with field 72 1 in FIG. 7. Field 944 of block 940 allows the user to view particular information regarding the first one of the first plurality of destinations, by pressing, clicking, or otherwise manipulating field 944. As an example, the information contained in field 944 can be similar to the information contained in block 420 in FIGS. 4 and 6. Field 945 of block 940 can perform a function similar to field 710 of block 310, and allows the user to delete the reservation for the first one of the first plurality of destinations, by pressing, clicking, or otherwise manipulating field 945. Field 946 of block 940 contains information regarding a total price for the selected reservations for the first and second pluralities of destinations. In one embodiment, a subroutine of the software program allows the user to transmit at least a portion of the information contained in screen display 900 to at least one e-mail address. In a particular embodiment, the portion of the information contained in screen display 900 can be e-mailed to as many as five e-mail addresses.

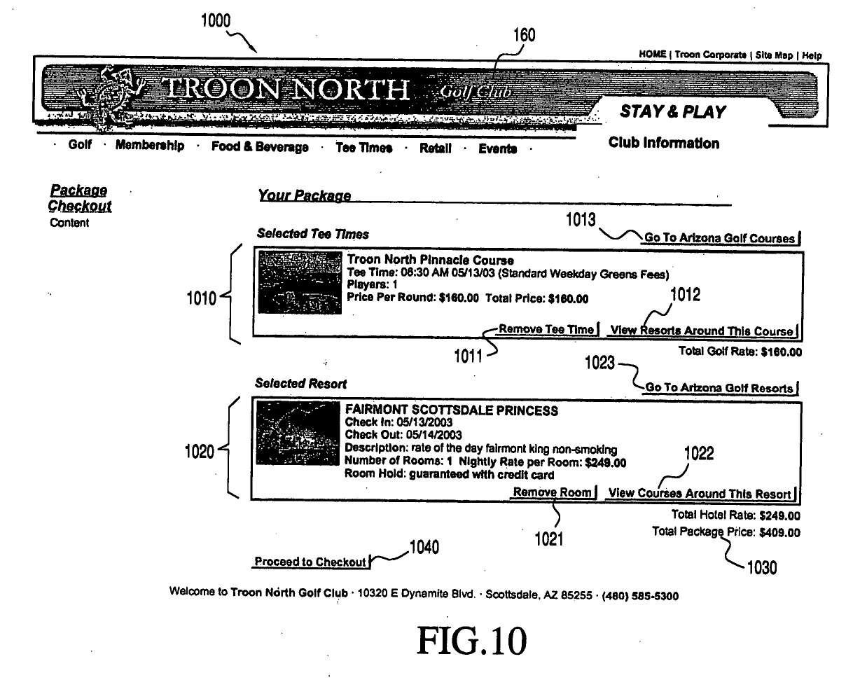

FIG. 10 is an illustration of a screen display 1000 generated by or in connection with a plurality of subroutines of the software program according to an embodiment of the invention. In one embodiment, screen display 1000 can be an alternative embodiment to screen display 900 in FIG. 9, and can contain information similar to at least a portion of the information contained in screen display 900 in FIG. 9. Screen display 1000 contains information summarizing selections made by the user regarding the first and second pluralities of destinations, and comprises blocks 160, 1010, and 1020. Block 1010 contains information regarding the first one of the first plurality of destinations, which information can include the information displayed in block 310 in FIGS. 7, 8, and 9. Block 1010 further comprises fields 1011, 1012, and 1013 that enable the user to view additional information and/or alter previously-entered selections regarding the first and second pluralities of destinations. Field 1011 allows the user to remove the tee time selected in connection with field 414 in FIGS. 4 and 6. Field 1012 allows the user to view information regarding additional ones of the second plurality of destinations having a particular relationship to the first one of the first plurality of destinations. As mentioned above, this particular relationship can be a maximum distance separating the additional ones of the second plurality of destinations from the first one of the first plurality of destinations. Field 1013 allows the user to view information regarding additional ones of the first plurality of destinations.

Block 1020 contains information regarding the first one of the second plurality of destinations, which information can include the information displayed in block 310 in FIG. 9. Block 1020 further comprises fields 1021, 1022, and 1023 that enable the user to view additional information and/or alter previously-entered selections regarding the first and second pluralities of destinations. Field 1021 allows the user to remove the room selected in connection with fields 821 in FIGS. 8 and 9. Field 1022 allows the user to view information regarding additional ones of the first plurality of destinations having a particular relationship to the first one of the second plurality of destinations. As mentioned above, this particular relationship can be a maximum distance separating the additional ones of the first plurality of destinations from the first one of the second plurality of destinations. Field 1023 allows the user to view information regarding additional ones of the first plurality of destinations.

Screen display 1000 further comprises fields 1030 and 1040. Field 1030 contains information regarding the total price of the reservations at the first one of the first plurality of destinations and the first one of the second plurality of destinations. Field 1040 allows the user to advance through the purchase process, by pressing, clicking, or otherwise manipulating field 1040. In one embodiment, a subroutine of the software program allows the user to transmit at least a portion of the information contained in screen display 1000 to at least one e-mail address. In a particular embodiment, the portion of the information contained in screen display 1000 can be e-mailed to as many as five e-mail addresses.

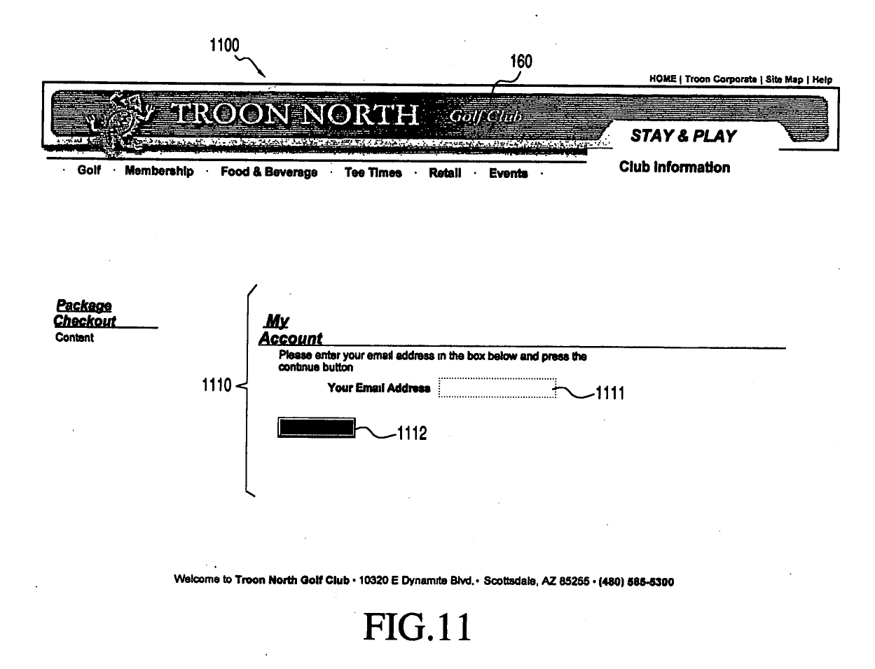

FIG. 11 is an illustration of a screen display 1100 generated by or in connection with a subroutine of the software program according to an embodiment of the invention. Screen display 1100 comprises a block 1110. Block 1110 comprises fields 1111 and 1112. The user may enter information regarding an e-mail address in field 1111, and may further advance through the purchase process by pressing, clicking, or otherwise manipulating field 1112.

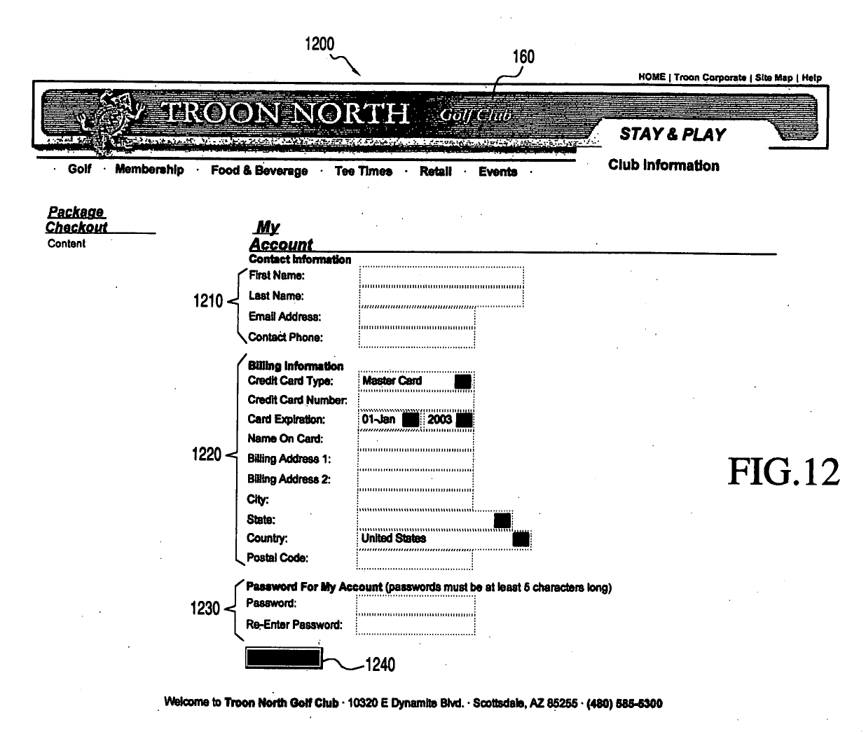

FIG. 12 is an illustration of a screen display 1200 generated by or in connection with a subroutine of the software program according to an embodiment of the invention. Screen display 1200 comprises blocks 160, 1210, 1220, and 1230. In block 1210 the user may enter the user's contact information. As an example, the user may enter information regarding the user's first and last names, e-mail address, and telephone number. In block 1220 the user may enter the user's billing information. As an example, the user may enter information regarding the user's credit card type, number, and expiration date, the name on the credit card, and the billing address for the credit card. In block 1230, the user may enter the user's password. Screen display 1200 further comprises a field 1240. Field 1240 allows the user to further advance through the purchase process by pressing, clicking, or otherwise manipulating field 1240. As an example, manipulating field 1240 may allow the user to confirm the information entered in connection with screen display 1200, confirm the user's desire to purchase the reservations, and/or receive a confirmation of purchased reservations.

In one embodiment of the invention, the reservation facilitator may receive a first inventory via the global information network from the first plurality of destinations. In the same or another embodiment, the reservation facilitator may receive a second inventory via the global information network from the second plurality of destinations. As an example, the first inventory may comprise a plurality of tee times available at a plurality of golf courses. As another example, the second inventory may comprise a plurality of hotel rooms available at a plurality of hotels. It will be understood that the first and second inventories may alternatively comprise different items, such as seat reservations at a theater or restaurant, tickets to an amusement park, or the like.

The inventory concept as it relates to an embodiment of the invention will now be discussed. “Shopping cart” applications have been used for many years on many websites, and have been employed by vendors of merchandise or reservations that are known to be available. Book sellers know what books they have available to ship from inventory. A user can place a number of “available” books in the shopping cart and purchase all of them at once. A seller of travel can sell an airline ticket, a hotel, a car, etc in a shopping cart method, but to do so the seller of travel must have already secured the inventory. With inventory in hand, i.e., under the control of a merchant, the merchant could sell these reservations in a shopping cart individually or as a package.

In at least one embodiment of the present invention, the user may select from a wide variety of destination, purchase, and/or reservation options, and a reservation facilitator can use the software program to instantaneously search for availability, whether or not the reservation facilitator has the destination, purchase, or reservation options currently in inventory. Certain particular embodiments of this selection and search process will be further described in connection with cases 1 through 5 below, any one of which, along with others not discussed, may be used with or enabled by the software program.

Case 1. A supplier provides a reservation facilitator with two tee times for each day of the year. The two tee times per day become inventory in the reservation facilitator's system that the reservation facilitator controls. When a user requests a tee time reservation corresponding to one of two tee times per day in the reservation facilitator's inventory, the search for the tee time is “static” in that the reservation facilitator's system need only search the reservation facilitator's own inventory. If the user further requests a hotel reservation, the search for the hotel reservation is “dynamic” in that the reservation facilitator's system will interface with the hotel chain's computer system that controls the inventory for the requested hotel. Case 1 is static and dynamic.

Case 2. The reservation facilitator must go through a third party who controls the access to live inventory at the golf course level for a tee time at a golf course, but has a hotel in its own inventory. Case 2 is dynamic and static, i.e., is the reverse of Case 1.

Case 3. The user requests a golf course and a hotel and the reservation facilitator needs to go through a third party for access to live inventory at the golf course level and must connect to the live inventory in the hotel chain's central reservation system. Case 3 is dynamic and dynamic.

Case 4. The same as Case 3, except that the user requests two or more golf courses and the second one of the golf courses provides the reservation facilitator with in-house inventory. Case 4 is dynamic, static, dynamic.

Case 5. A user places selections in a shopping cart as discussed above. Case 5 is entirely static.

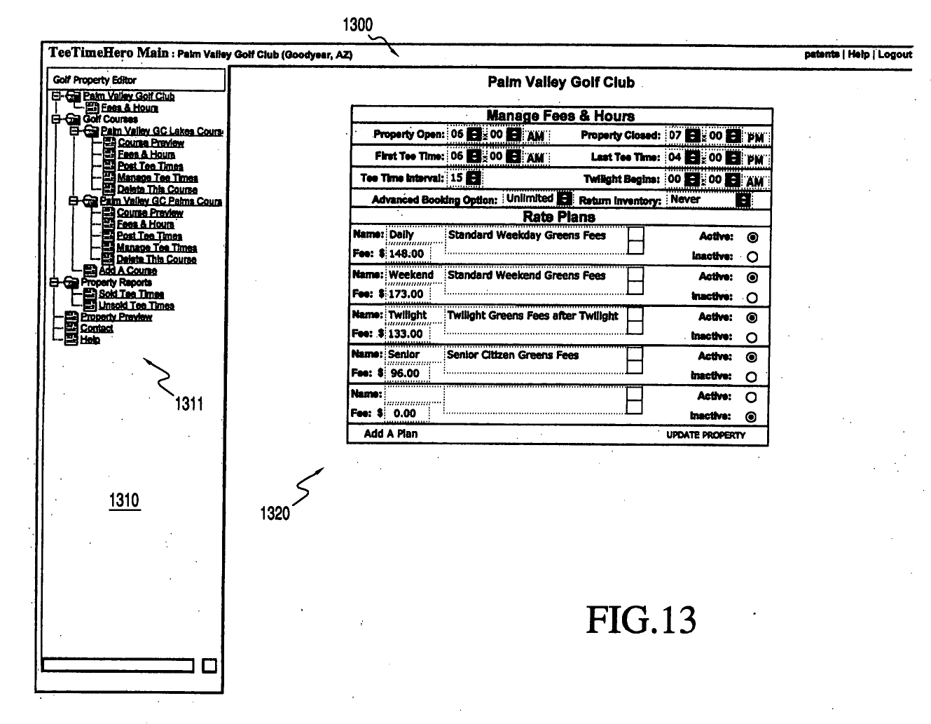

FIG. 13 is an illustration of a screen display 1300 according to an embodiment of the invention. Screen display 1300 allows a person associated with one of the first or second pluralities of destinations, referred to herein as a “supplier,” to manage aspects of the first or second inventories provided to the reservation facilitator. In FIGS. 13-19, the first plurality of destinations will be assumed to be a plurality of golf courses, and the supplier will be assumed to be a person affiliated with one of the plurality of golf courses. As it is used herein, the term “person” means any legal entity, including a natural person, a corporation, a partnership, and the like.

Screen display 1300 comprises blocks 1310 and 1320. Block 1310 contains a plurality of fields 1311, each of which allow the supplier to manage one or more aspects of the first or second pluralities of inventories. As an example, certain ones of fields 1311 may be used to manage, manipulate, or otherwise access information regarding purchasers of reservations. As an example, the information regarding the purchasers of reservations may comprise information useful for accounting, marketing, or other purposes. As a particular example, the information regarding purchasers of reservations may comprise the name of a particular purchaser of a reservation and/or how much money the particular purchaser spent on the reservation. As another example, the information regarding the purchasers of reservations may comprise information regarding a number of tee times sold on a particular day. Certain additional ones of fields 1311 and their functions will be further described below. Block 1320 allows the supplier to manage information related to fees and hours at the golf course.

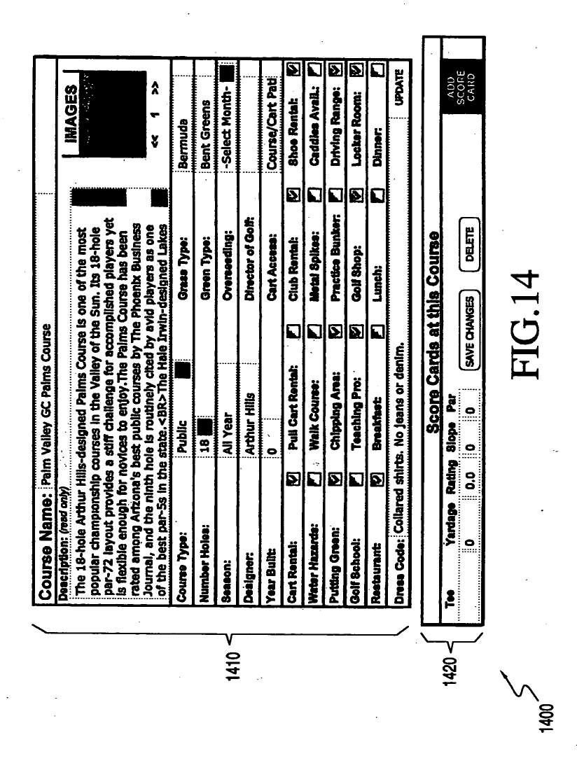

FIG. 14 is an illustration of a screen display 1400 according to an embodiment of the invention. Screen display 1400 comprises blocks 1410 and 1420. Block 1410 allows the supplier to enter information regarding a golf course. As an example, the information that may be entered in block 1410 can be similar to the information displayed in block 420 of FIGS. 4, 6, and 7. Block 1420 allows the supplier to enter information regarding a score card at the golf course. Using block 1420, the supplier can add a new score card and/or edit an existing scorecard.

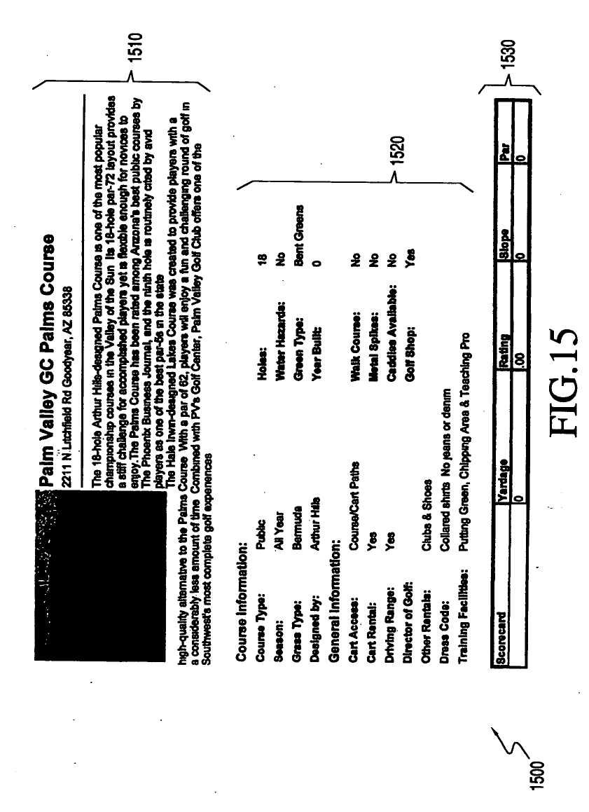

FIG. 15 is an illustration of a screen display 1500 according to an embodiment of the invention. Screen display 1500 comprises blocks 1510, 1520, and 1530. Block 1510 contains information regarding the golf course. As an example, block 1510 can contain information in both graphic and textual form. As a further example, the information contained in block 1510 can be similar to the information contained in block 320 in FIGS. 3 and 5 and block 410 in FIGS. 4, 6, and 7. Block 1520 contains information regarding the golf course. As an example, the information contained in block 1520 can be similar to the information contained in block 420 of FIGS. 4, 6, and 7 and in block 1410 in FIG. 14. Block 1530 contains information regarding a score card at the golf course, which information can be similar to the information contained in block 1420 in FIG. 14.

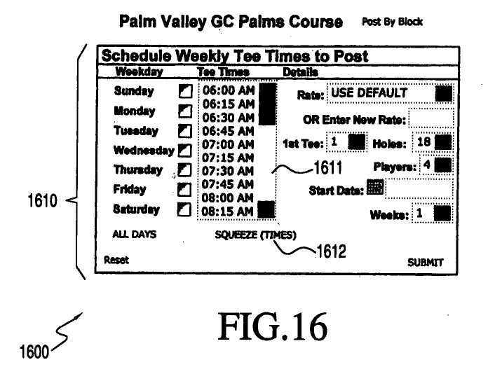

FIG. 16 is an illustration of a screen display 1600 according to an embodiment of the invention. Screen display 1600 can be used to post tee times at the golf course, and comprises a block 1610. Block 1610 comprises fields 1611, 1612, and 1613. Field 1611 contains information regarding available tee times at the golf course. In one embodiment, block 1610 or another block is capable of alerting the supplier when a number of the available tee times reaches a pre-determined level.

In the illustrated embodiment, a space of 15 minutes separates each available tee time from both the preceding and the next available tee time. Some golf courses have made use of what are referred to herein as “squeeze times,” which are tee times “squeezed” in between standard tee times. Field 1612 allows the supplier to display at least one potential tee time, such as one or more available squeeze times, in field 1611, for example, by pressing, clicking, or otherwise manipulating field 1612.

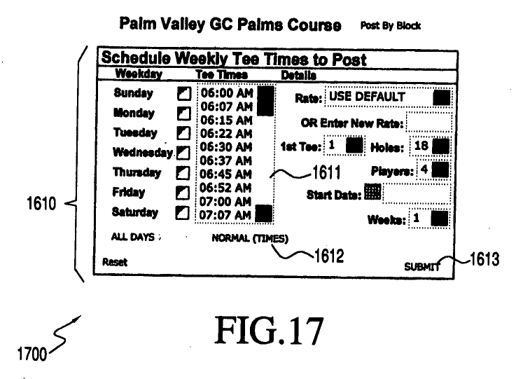

FIG. 17 is an illustration of a screen display 1700 wherein field 1611 displays a plurality of squeeze times in addition to a plurality of standard tee times. In the illustrated embodiment, each squeeze time is separated from the preceding standard tee time by seven minutes and from the next standard tee time by eight minutes. Different amounts of separation could also be used for squeeze times. Field 1613 allows the supplier to post the available tee times, by pressing, clicking, or otherwise manipulating field 1613.

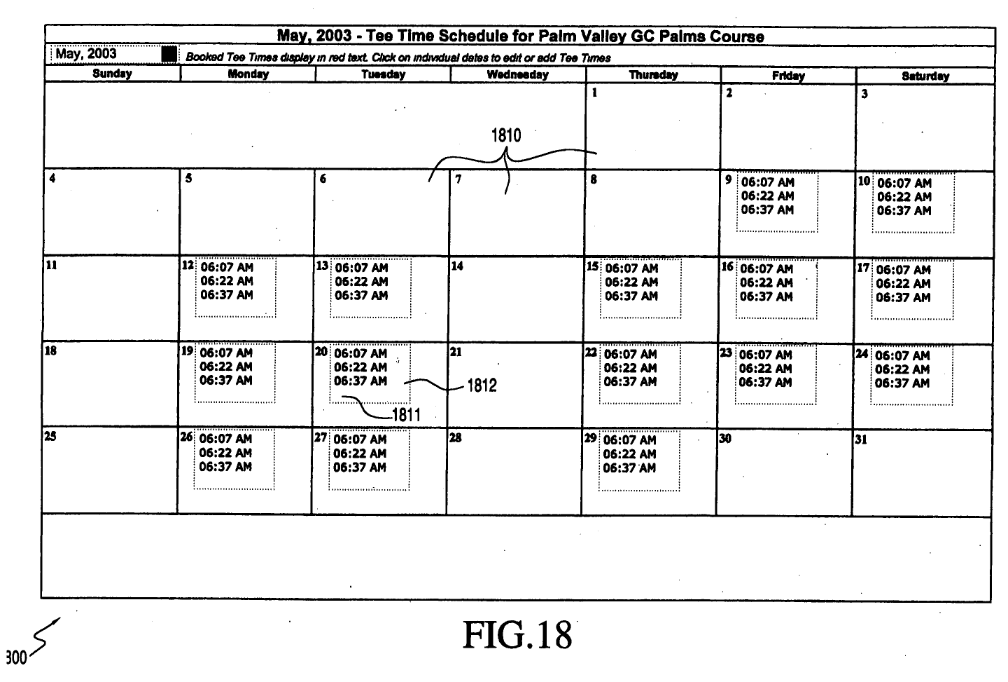

FIG. 18 is an illustration of a screen display 1800 according to an embodiment of the invention. Screen display 1800 comprises a plurality of blocks 1810. In the illustrated embodiment, each block 1810 corresponds to a day in May of 2003. Screen display 1800 can thus function like a calendar. According to information entered by the supplier, such as information entered in block 1610 in FIGS. 16 and 17, certain ones of blocks 1810 contain windows 1811. The blocks 1810 containing windows 1811 are those blocks 1810 that correspond to the days that the supplier has previously identified as having available tee times, which days are referred to herein as “identified days.” As an example, the identified days can be the days identified in block 1610 if FIGS. 16 and 17. Windows 1811 contain one or more entries 1812 regarding one or more available tee times for the identified days.

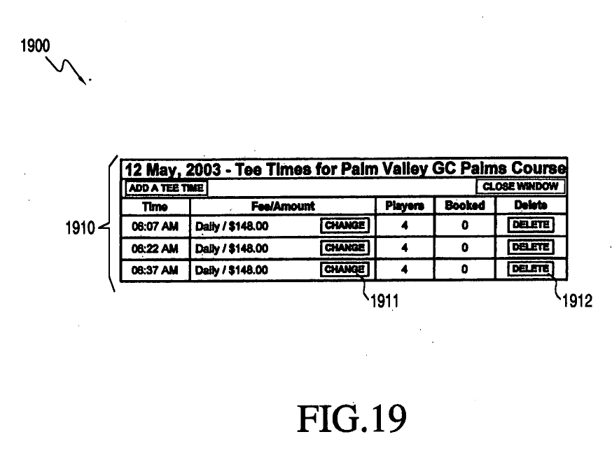

FIG. 19 is an illustration of a screen display 1900 according to an embodiment of the invention. Screen display 1900 comprises a block 1910. Using block 1910, the information contained in blocks 1810 can be altered, managed, or otherwise manipulated. A field 1911 of block 1910 allows the supplier to alter, manage, or otherwise manipulate information regarding the fee for a tee time. A field 1912 of block 1910 allows the supplier to delete a tee time, by pressing, clicking, or otherwise manipulating field 1912.

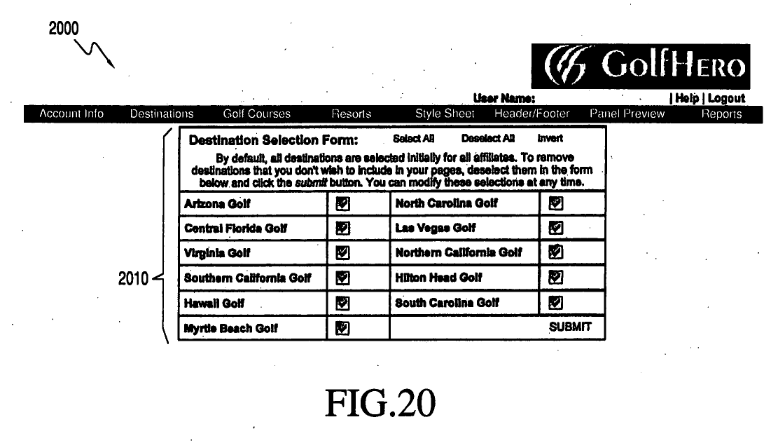

In one embodiment of the invention, a person other than the reservation facilitator may use the software program to sell reservations at the first and/or second pluralities of destinations in selected geographical locations. Such a person is referred to herein as an “affiliate manager.” Examples of screen displays that may be used by an affiliate manager are depicted in FIGS. 20-23.

FIG. 20 is an illustration of a screen display 2000 according to an embodiment of the invention. Screen display 2000 comprises a block 2010. In block 2010, an affiliate manager may select particular geographical locations in which are located particular ones of the first and/or second pluralities of destinations to which the affiliate manager desires to sell reservations.

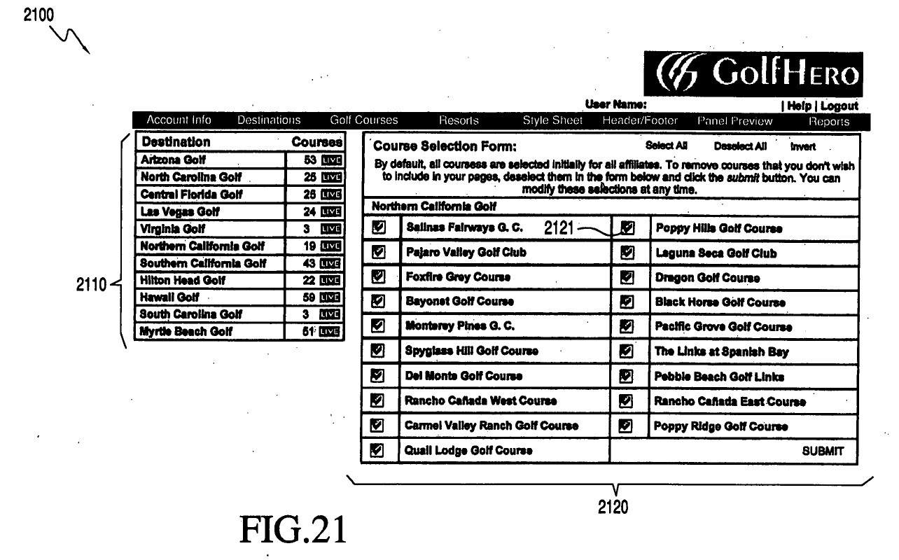

FIG. 21 is an illustration of a screen display 2100 according to an embodiment of the invention. Screen display 2100 comprises blocks 2110 and 2120. Block 2110 contains information regarding the particular geographical locations in which are located particular ones of the first and/or second pluralities of destinations to which the affiliate manager desires to sell reservations. As an example, block 2110 may contain the information selected in block 2010 of FIG. 20. Block 2120 of screen display 2100 contains information regarding the particular ones of the first and/or second pluralities of destinations to which the affiliate manager desires to sell reservations. In the illustrated embodiment, block 2120 contains information regarding a plurality of golf courses located in a particular geographical location. Fields 2121 in block 2120 allow the affiliate manager to select or deselect particular ones of the plurality of golf courses located in the particular geographical location.

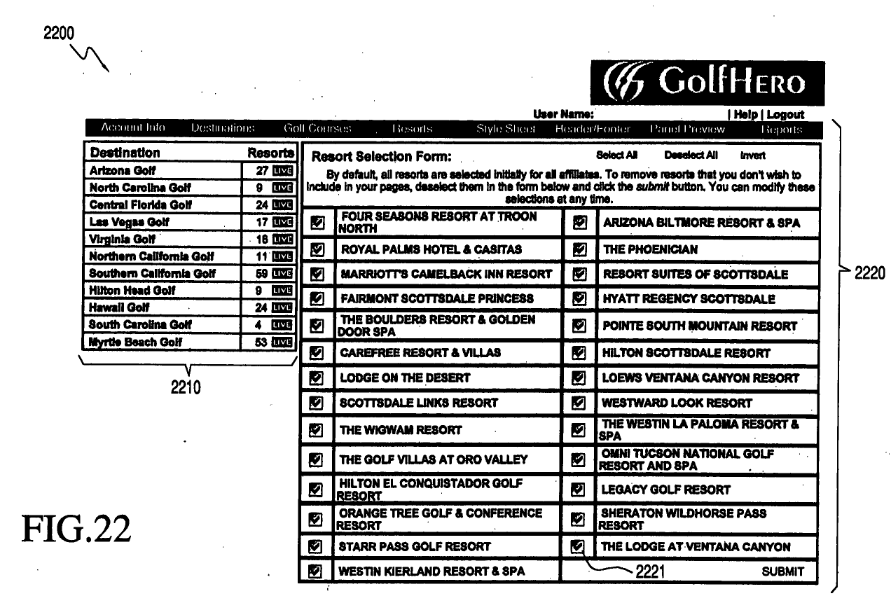

FIG. 22 is an illustration of a screen display 2200 according to an embodiment of the invention. Screen display 2200 comprises blocks 2210 and 2220. Block 2210 contains information regarding the particular geographical locations in which are located particular ones of the first and/or second pluralities of destinations to which the affiliate manager desires to sell reservations. Block 2220 of screen display 2200 contains information regarding the particular ones of the first and/or second pluralities of destinations to which the affiliate manager desires to sell reservations. In the illustrated embodiment, block 2220 contains information regarding a plurality of hotels located in a particular geographical location. Fields 2221 in block 2220 allow the affiliate manager to select or deselect particular ones of the plurality of hotels located in the particular geographical location.

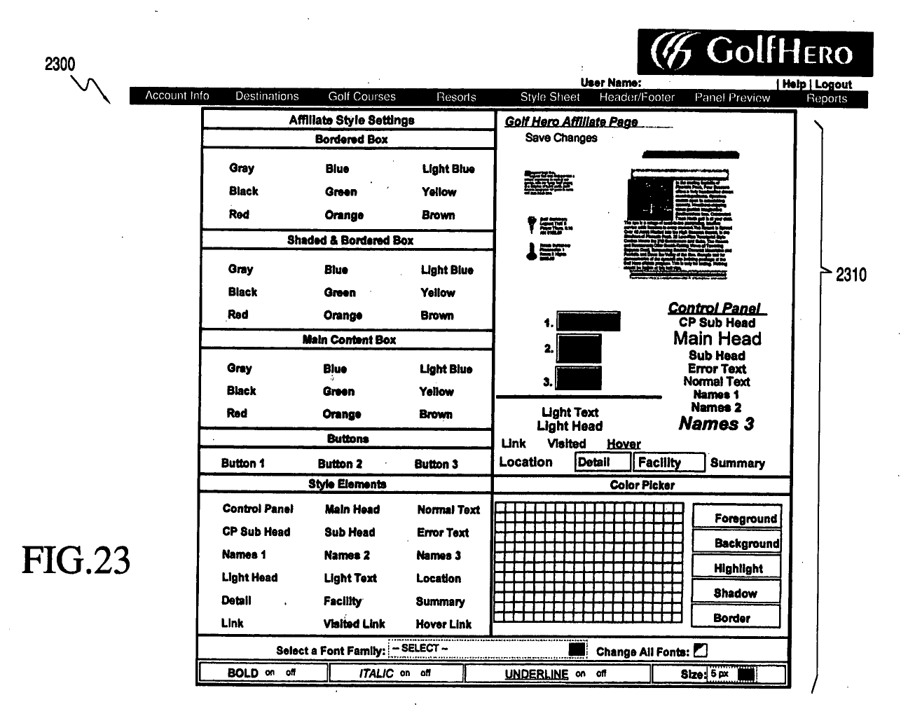

FIG. 23 is an illustration of a screen display 2300 according to an embodiment of the invention. Screen display 2300 is a style sheet that allows the affiliate manager to customize the appearance of the web site and/or the screen displays seen by a purchaser of reservations, and comprises a block 2310. As an example, block 2310 can allow the affiliate manager to customize a font size, a font color, a border style, a box style, a button style, and the like.

FIG. 24 is a flow chart illustrating a method 2400 of facilitating a purchase over a global information network according to an embodiment of the invention. Method 2400 comprises steps 2410, 2420, 2430, 2440, 2450, 2460, 2470, 2480, and 2490. Step 2410 of method 2400 is to provide information regarding a first plurality of destinations on a web site. Step 2420 of method 2400 is to provide information regarding a second plurality of destinations on the web site. In one embodiment of method 2400, providing information regarding the first plurality of destinations can comprise one sub-step and providing information regarding the second plurality of destinations can comprise a separate sub-step of a single step. As an example, the first plurality of destinations can be a plurality of golf courses and the second plurality of destinations can be a plurality of hotels. As a further example, the information provided in steps 2410 and 2420 can be similar to the information in: block 130 in FIG. 1; block 230 in FIG. 2; block 320 in FIGS. 3 and 5; blocks 410, 420, and 430 in FIGS. 4, 6, and 7; and blocks 810, 820, and 830 in FIGS. 8 and 9. In a different embodiment, step 2420 can occur later in method 2400, such as, for example, between steps 2460 and 2470, between steps 2470 and 2480, or between steps 2480 and 2490.

Step 2430 of method 2400 is to receive a first selection regarding a first one of the first plurality of destinations from a user via the global information network. As an example, the first selection can be a selection of a particular golf course from among the plurality of golf courses. As a particular example, the first selection can be made from among the plurality of golf courses about which information is contained in block 320 of FIGS. 3 and 5. In one embodiment, step 2430 can comprise receiving the first selection directly or indirectly from an intermediary. Subsequently-described steps can also involve an intermediary, where appropriate.

Step 2440 of method 2400 is to transmit information regarding the first selection via the global information network to the user in response to the first selection. As an example, transmitting information regarding the first selection can produce a screen display similar to screen display 400 in FIG. 4, screen display 600 in FIG. 6, and screen display 700 in FIG. 7.

Step 2450 of method 2400 is to receive a second selection regarding the first one of the first plurality of destinations via the global information network from the user. As an example, the second selection can be a selection of a particular tee time from among a plurality of available tee times at the particular golf course selected in step 2430. As a particular example, the first selection can be made from among the tee times displayed in field 413 in FIGS. 4, 6, and 7.

Step 2460 of method 2400 is to transmit information regarding the second selection via the global information network to the user in response to the second selection. As an example, transmitting information regarding the second selection can produce a screen display similar to screen display 700 in FIG. 7.

Step 2470 of method 2400 is to receive a third selection regarding the second plurality of destinations via the global information network from the user. As an example, the third selection can be a selection of a maximum distance between the first one of the first plurality of destinations and each one of the second plurality of destinations. As a particular example, the third selection can be a selection of a maximum distance between the particular golf course selected in step 2430 and each one of a plurality of hotels. In one embodiment, the maximum distance can be calculated in a substantially straight line between the first one of the first plurality of destinations and each one of the second plurality of destinations. In another embodiment, the maximum distance can take into account a distance traveled by road between the two destinations. As another example, the third selection can be a selection of desired amenities, a selection of quality (e.g., four-star, five-star, etc.), a selection of a cost range, or the like at each one of the second plurality of destinations.

Step 2480 of method 2400 is to transmit information regarding only a portion of the second plurality of destinations for the user based on the third selection. As an example, transmitting information regarding the portion of the second plurality of destinations based on the third selection can produce a screen display similar to screen display 600 in FIG. 6 and screen display 700 in FIG. 7. As a particular example, the transmitted information regarding the portion of the second plurality of destinations based on the third selection can be similar to the information contained in block 730 in FIG. 7. In one embodiment, a person affiliated with the first one of the first plurality of destinations may select a sub-portion of the portion of the second plurality of destinations about which information is transmitted for the user. As an example, the sub-portion of the portion of the second plurality of destinations can comprise destinations with which the first one of the first plurality of destinations has a partnership, a cross-marketing relationship, or some other relationship or understanding.

Step 2490 of method 2400 is to receive a fourth selection regarding a first one of the portion of the second plurality of destinations via the global information network from the user. As an example, the fourth selection can be a selection of a particular hotel from among the plurality of hotels making up the portion of the second plurality of destinations. Step 2490 is followed by a box A, representing a transition step from method 2400 in FIG. 24 to its continuation described in FIG. 25.

FIG. 25 is a flow chart illustrating a method 2500 of facilitating a purchase over a global information network according to an embodiment of the invention. Method 2500 is a continuation of method 2400, described in FIG. 24, and begins at box A in FIG. 25. Box A in FIG. 25 represents the same transition step as that represented by box A in FIG. 24. Referring to FIG. 25, method 2500 comprises steps 2510, 2520, 2530, and 2540. Step 2510 of method 2500 is to transmit information regarding the fourth selection via the global information network to the user based on the fourth selection. As an example, transmitting information regarding the fourth selection can produce a screen display similar to screen display 800 in FIG. 8 and screen display 900 in FIG. 9.

Step 2520 of method 2500 is to receive a fifth selection regarding the first one of the portion of the second plurality of destinations via the global information network from the user. As an example, the fifth selection can be a selection of a particular room at the particular hotel selected in connection with step 2490. As a particular example, the fifth selection can be made from among the hotel rooms about which information is contained in block 820 of FIGS. 8 and 9.

Step 2530 of method 2500 is to transmit information regarding the fifth selection via the global information network to the user based on the fifth selection. As an example, transmitting information regarding the fifth selection can produce a screen display similar to screen display 900 in FIG. 9.

Step 2540 of method 2500 is to permit the user to simultaneously purchase reservations for particular ones of the first and second plurality of destinations based on the first, second, third, fourth, and fifth selections. As an example, permitting the user to simultaneously purchase reservations for particular ones of the first and second plurality of destinations can comprise requiring the user to enter customer information, including billing information, only a single time, rather than entering such information separately for each reservation.

FIG. 26 is a block diagram of a system 2600 for facilitating a purchase over a global information network according to an embodiment of the invention. As an example, system 2600 can be an embodiment of the method and software program described in connection with FIGS. 1-25. System 2600 comprises a computer system 2610, which in turn comprises a memory 2611. Memory 2611 comprises a software program 2612 and a database 2613. Software program 2612 comprises subroutines 2614. Computer system 2610 can further comprise such non-illustrated components as: (1) data-entry devices, such as keyboards, computer mice, or the like, capable of entering data into system 2600); (2) displays, such as monitors or the like, capable of displaying data entered into system 2600; and (3) data-output devices, such as printers or the like. A connection 2620 is located between computer system 2610 and a global information network 2630.

As an example, the software program described previously with reference to FIGS. 1-25 can be embodied or stored on memory 2611 to be run on computer system 2610 in FIG. 26. For instance, each of subroutines 2614 in FIG. 26 can perform one or more of the steps in methods 2400 and 2500 in FIGS. 24 and 25. As another example, the first, second, third, fourth, fifth, and other selections described previously with reference to FIGS. 1-25 can also be embodied or stored on memory 2611. As a further example, global information network 2630 may be the Internet.

System 2600 further comprises global information network 2630, a first plurality of destinations 2640, a second plurality of destinations 2650, a plurality of user computers 2660, and at least one affiliate 2670. A plurality of connections 2645 connects first plurality of destinations 2640 and second plurality of destinations 2650 to global information network 2630. A plurality of connections 2665 connects plurality of user computers 2660 to global information network 2630. A connection 2675 connects affiliate 2670 to global information network 2630. Affiliate 2670 is explained in more detail below.

FIG. 27 is a block diagram of a system 2700 for facilitating a purchase over a global information network. As an example, system 2700 can be an embodiment of the method and software program described in connection with FIGS. 1-25. System 2700 comprises a switch 2710, a plurality of affiliates 2720 connected to switch 2710 via a plurality of Internet application programming interfaces 2711, a plurality of suppliers 2730 also connected to switch 2710 via plurality of Internet application programming interfaces 2711, and a database 2740 connected to switch 2710. As an example, database 2740 can contain information regarding a first plurality of destinations, such as a plurality of golf courses.

As an example, affiliates 2720 in FIG. 27 and affiliate 2670 in FIG. 26 can be entities in the business of facilitating travel, such as travel agencies, Priceline.com, Expedia.com, Travelocity, Orbitz, and the like. As another example, affiliates 2720 can be entities in the business of selling golf-related equipment or the like. As still another example, suppliers 2730 can be destinations within the first and/or second pluralities of destinations, or suppliers 2730 can be intermediaries, such as intermediaries affiliated or connected with one or more destinations within the first and/or second pluralities of destinations.

System 2700 further comprises a plurality of users 2721 and a plurality of destinations 2731. As an example, users 2721 can access switch 2710 via affiliates 2720, and can be connected to affiliates 2720 by a plurality of Internet connections 2712. As another example, plurality of destinations 2731 can comprise a plurality of destinations within the first and/or second plurality of destinations, and can be connected to suppliers 2730 via plurality of Internet connections 2712. As a particular example, plurality of destinations 2731 can include a plurality of golf courses and/or a plurality of hotels.

FIG. 28 is a block diagram of a system 2800 for facilitating a purchase over a global information network. As an example, system 2800 can be an embodiment of the method and software program described in connection with FIGS. 1-25. The embodiment of system 2800 illustrated in FIG. 28 is a system for facilitating a purchase of reservations at golf courses and/or hotels. System 2800 comprises a golf tee time switch 2810 and an extensible markup language (XML) golf tee time feed 2815, a golf database 2820, external tee time providers 2830, and an application programming interface (API) 2840, all connected to golf tee time switch 2810.

As an example, golf tee time switch 2810 can take an XML request, perform the requested action, and return results in XML. As further examples, golf tee time switch 2810 can serve golf course content from golf database 2820, including photographs and geographical location information regarding a golf course; perform searches for golf courses by specific geographical location information, distance from another destination, address parameters, and the like; perform searches for tee time inventory from golf database 2820 and/or external tee time providers 2830; and create reservations for tee times at a particular golf course or courses. As a further example, XML golf tee time feed 2815 can be a push pull system that can be used to create golf tee time reservations. The use of XML allows for platform-independent implementation. XML golf tee time feed 2815 is a data feed, thus allowing seamless implementation, enabled by golf tee time switch 2810, into existing or new systems.

As another example, golf database 2820 can contain golf course content such as descriptions, photographs, hours of operation, prices for a round of golf, golf course rules, geographical locations, scorecards, and the like for a plurality of golf courses; a blocked inventory system allowing the posting of tee times for sale on-line; and all data that may be edited by affiliates, as well as affiliate accounts and preferences. As another example, external tee time providers 2830 can be entities that hold tee time inventory available for purchase on-line through an API, such as TeeTimes.com, EZLinks.com, and the like.

As another example, API 2840 can be an API against which applications are written and that contains business rules and-other commonly used utilities, and handles conversations with external providers. API 2840 can also be a hub that calls one or more subroutines of the software program depending on an action required in response to a selection entered by a user of the software program. API 2840 allows the business rules to be kept clean and strictly managed by having one source that many applications can be written against.

System 2800 further comprises a packaging system 2841, a hotel database 2850, and a plurality of central reservation systems 2860 connected to API 2840. As an example, hotel database 2850 can be provided by one or more of plurality of central reservation systems 2860. System 2800 still further comprises a program manager interface 2821 connected to golf database 2820, and a supplier management interface 2822 and an affiliate account management interface 2823, both connected to program manager interface 2821. Affiliate account management interface 2823 comprises a style sheet editor 2824.

As an example, packaging system 2841 can be an on-line reservation system that allows packaging of at least two components of a travel offering, where such components can include airplane tickets, car rentals, hotel rooms, golf tee times, amusement park tickets, and the like, in a process that only prompts the user to enter customer information one time. As another example, hotel database 2850 can contain hotel content such as descriptions, photographs, amenities, prices for a room at the hotel, hotel rules, geographical locations, accounting data, and the like for a plurality of hotels. As a further example, plurality of central reservation systems 2860 can include one or more of the commercially available central reservation systems or global distribution systems, such as Pegasus and Worldspan, that can provide information regarding hotels, airlines, car rental companies, and the like. As a still further example, program manager interface 2821 can be a general interface allowing back end management for system 2800. In one embodiment, program manager interface 2821 can include supplier management interface 2822 and affiliate account management interface 2823.

As a still further example, supplier management interface 2822 can be a comprehensive back end solution that can be similar to a complete golf course tee sheet system. Using supplier management interface 2822, a supplier can create and/or update information regarding a golf course with which the supplier is associated, including information regarding scheduling, hours of operation, fees, business rules, and the like. A supplier can also provide inventory in a block and/or provide inventory comprising squeeze times in conjunction with or in place of standard tee times. Supplier management interface 2822 can further comprise reporting functions that can allow a supplier to keep track of inventory sold, inventory not sold, sales totals, commissions due, customer information, and the like.

As another example, affiliate account management interface 2823 can include an affiliate information editor that allows an affiliate to edit its account information and/or its preferences for the display areas of the software program and/or the screen displays described in connection with at least FIGS. 1-12. The affiliate information editor can allow an affiliate to maintain its own website's look and feel. The affiliate information editor, in at least one embodiment, can act in connection with style sheet editor 2824.

As an example, style sheet editor 2824 can be a real-time visualization tool for editing style preferences. Style sheet editor 2824 can allow a person associated with an affiliate to make changes visually and instantly see those changes in a miniature representation of the application layout before committing to them in a live environment and without the need to enter numbers or colors. In one embodiment, style sheet editor 2824 can be a dynamic JavaScript-driven what-you-see-is-what-you-get (WYSIWYG) application.

Affiliate account management interface 2823 can further comprise a preference editor that can be used to allow a person associated with an affiliate to select destinations, such as hotels and golf courses, to be included in the affiliate's application. In one embodiment, the application can use exclusion filters to reduce processing time. Affiliate account management interface 2823 can still further comprise a reporting and accounting interface that can provide real-time reports regarding sales and accounting, including billing and statistics. The affiliate management interface 2823 can be used to upload a header and footer, e.g., in hypertext markup language (html) format, to wrap around the application content. Alternatively, an affiliate can use a default header and/or footer and only upload its logo.

Although the invention has been described with reference to specific embodiments, it will be understood by those skilled in the art that various changes may be made without departing from the spirit or scope of the invention. Various examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the software program discussed herein may be implemented in a variety of embodiments, and that the foregoing discussion of certain of these embodiments does not necessarily represent a complete description of all possible embodiments.

Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims. Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A software program for facilitating a purchase over a global information network, the software program comprising:
a first subroutine capable of providing information regarding a first plurality of destinations on a web site;
a second subroutine capable of providing information regarding a second plurality of destinations on the web site;
a third subroutine capable of receiving a first selection regarding a first one of the first plurality of destinations via the global information network;
a fourth subroutine capable of transmitting information regarding the first selection via the global information network;
a fifth subroutine capable of transmitting information, based on the first selection, regarding only a portion of the second plurality of destinations via the global information network;
a sixth subroutine capable of, after transmitting the information regarding the portion of the second plurality of destinations, receiving a second selection regarding a first one of the portion of the second plurality of destinations via the global information network;
a seventh subroutine capable of transmitting information regarding the second selection via the global information network; and
an eighth subroutine capable of permitting simultaneous purchasing of reservations for the first and second pluralities of destinations based on the first and second selections.

2. The software program of claim 1 further comprising:
a ninth subroutine capable of, after transmitting the information regarding the first selection, receiving a third selection regarding the first one of the first plurality of destinations via the global information network; and
a tenth subroutine capable of transmitting information regarding the third selection via the global information network,
wherein:
the eighth subroutine is capable of permitting simultaneous purchasing of reservations for the first and second pluralities of destinations based on the first, second, and third selections.

3. The software program of claim 1 further comprising:
a ninth subroutine capable of, after transmitting information regarding the second selection, receiving a third selection regarding the first one of the portion of the second plurality of destinations via the global information network; and
a tenth subroutine capable of transmitting information regarding the third selection via the global information network, wherein:
the eighth subroutine is capable of permitting simultaneous purchasing of reservations for the first and second pluralities of destinations based on the first, second, and third selections.

4. The software program of claim 3 further comprising:
an eleventh subroutine capable of, after transmitting the information regarding the first selection, receiving a fourth selection regarding the first one of the first plurality of destinations via the global information network; and
a twelfth subroutine capable of transmitting information regarding the fourth selection via the global information network,
wherein:
the eighth subroutine is capable of permitting simultaneous purchasing of reservations for the first and second pluralities of destinations based on the first, second, third, and fourth selections.

5. The software program of claim 4 wherein:
each one of the first plurality of destinations is a golf course.

6. The software program of claim 5 further comprising:
a thirteenth subroutine capable of transmitting information regarding at least one potential tee time via the global information network to a person associated with one of the first plurality of destinations.

7. The software program of claim 5 wherein:
each one of the second plurality of destinations is a hotel.

8. The software program of claim 7 wherein:
the third subroutine is further capable of:
receiving an identification of a golf course.

9. The software program of claim 8 wherein:
the fourth subroutine is further capable of:
transmitting information selected from the group consisting of: a name of the golf course; an address of the golf course; a description of the golf course; roles for the golf course; available tee times at the golf course; and a price for a round of golf at the golf course.

10. The software program of claim 9 wherein:
the available tee times are selected by a person associated with the golf course.

11. The software program of claim 10 further comprising:
a thirteenth subroutine capable of alerting the person associated with the golf course when a number of the available tee times decreases below a pre-determined level.

12. The software program of claim 8 wherein:
the eleventh subroutine is further capable of:
receiving an identification of a tee time at the golf course.

13. The software program of claim 12 wherein:
the twelfth subroutine is further capable of:
transmitting information selected from the group consisting of: a name of the golf course; the tee time at the golf course; and a number of players to play the round of golf.

14. The software program of claim 8 wherein:
the third subroutine is further capable of:
receiving information regarding a maximum distance between the first one of the first plurality of destinations and each one of the second plurality of destinations.

15. The software program of claim 14 wherein:
the portion of the second plurality of destinations comprises:
each one of the second plurality of destinations within the maximum distance from the first one of the first plurality of destinations.

16. The software program of claim 14 wherein:
the portion of the second plurality of destinations comprises:
at least one of the second plurality of destinations within the maximum distance from the first one of the first plurality of destinations.

17. The software program of claim 16 wherein:
the fifth subroutine is further capable of:
transmitting information regarding less than all of the second plurality of destinations within the maximum distance from the first one of the first plurality of destinations.

18. The software program of claim 14 wherein:
the sixth subroutine is further capable of:
receiving an identification of a hotel.

19. The software program of claim 18 wherein:
the seventh subroutine is further capable of:
transmitting information selected from the group consisting of: a name of the hotel; an address of the hotel; a description of the hotel; available rooms at the hotel; a description of the available rooms; a number of occupants allowed in each of the available rooms; rules of the hotel; and a price for each of the available rooms.

20. The software program of claim 1;9 wherein:
the available rooms are selected by a person associated with the hotel.

21. The software program of claim 20 further comprising:
a thirteenth subroutine capable of alerting the person associated with the hotel when a number of the available rooms decreases below a pre-determined level.

22. The software program of claim 4 wherein:
the ninth subroutine is further capable of:
receiving an identification of one of the available rooms.

23. The software program of claim 22 wherein:
the tenth subroutine is further capable of:
transmitting information selected from the group consisting of: a name of the hotel; a cost per night at the hotel for the one of the available rooms; and a description of the one of the available rooms.

24. The software program of claim 4 further comprising:
a thirteenth subroutine capable of allowing a first person affiliated with one of the first plurality of destinations or the second plurality of destinations to change an appearance of a portion of the web site related to the one of the first plurality of destinations or the second plurality of destinations with which the first person is associated.

25. The software program of claim 4 further comprising:
allowing a second person affiliated with an intermediary to change an appearance of a portion of the web site.

26. The software program of claim 25 wherein:
a user transmits the first, second, third, fourth, and fifth selections to the intermediary; and
the first subroutine is further capable of receiving the first selection from the intermediary.

27. The software program of claim 4 further comprising:
a thirteenth subroutine capable of transmitting information regarding a user making the first, second, third, fourth, and fifth selections to at least one of the first and second pluralities of destinations.

28. A method of facilitating a purchase over a global information network, the method comprising:
providing information regarding a first plurality of destinations on a web site;
providing information regarding a second plurality of destinations on the web site;
receiving a first selection regarding a first one of the first plurality of destinations via the global information network;
transmitting information regarding the first selection via the global information network;
based on the first selection, transmitting information regarding only a portion of the second plurality of destinations via the global information network;
after transmitting the information regarding the portion of the second plurality of destinations, receiving a second selection regarding a first one of the portion of the second plurality of destinations via the global information network;
transmitting information regarding the second selection via the global information network; and
permitting simultaneous purchasing of reservations for the first and second pluralities of destinations based on the first and second selections.

29. The method of claim 28 further comprising:
after transmitting the information regarding the first selection, receiving a third selection regarding the first one of the first plurality of destinations via the global information network;
transmitting information regarding the third selection via the global information network; and
permitting simultaneous purchasing of reservations for the first and second pluralities of destinations based on the first, second, and third selections.

30. The method of claim 28 further comprising:
after transmitting information regarding the second selection, receiving a third selection regarding the first one of the portion of the second plurality of destinations via the global information network;
transmitting information regarding the third selection via the global information network; and
permitting simultaneous purchasing of reservations for the first and second pluralities of destinations based on the first, second, and third selections.

31. The method of claim 30 further comprising:
after transmitting the information regarding the first selection, receiving a fourth selection regarding the first one of the first plurality of destinations via the global information network;
transmitting information regarding the fourth selection via the global information network; and
permitting simultaneous purchasing of reservations for the first arid second pluralities of destinations based on the first, second, third, and fourth selections.

32. The method of claim 31 wherein:
each one of the first plurality of destinations is a golf course.

33. The method of claim 32 further comprising:
transmitting information regarding at least one potential tee time via the global information network to a person associated with one of the first plurality of destinations.

34. The method of claim 32 wherein:
each one of the second plurality of destinations is a hotel.

35. The method of claim 34 wherein:
receiving the first selection comprises:
receiving an identification of a golf course.

36. The method of claim 35 wherein:
transmitting information regarding the first selection comprises:
transmitting information selected from the group consisting of a name of the golf course; an address of the golf course; a description of the golf course; rules for the golf course; available tee times at the golf course; and a price for a round of golf at the golf course.

37. The method of claim 36 wherein:
the available tee times are selected by a person associated with the golf course.

38. The method of claim 37 further comprising:
alerting the person associated with the golf course when a number of the available tee times decreases below a pre-determined level.

39. The method of claim 35 wherein:
receiving the second selection comprises:
receiving an identification of a tee time at the golf course.

40. The method of claim 39 wherein:
transmitting information regarding the second selection comprises:
transmitting information selected from the group consisting of: a name of the golf course; the tee time at the golf course; and a number of players to play a round of golf at the golf course.

41. The method of claim 35 wherein:
receiving the third selection comprises:
receiving information regarding a maximum distance between the first one of the first plurality of destinations and each one of the second plurality of destinations.

42. The method of claim 41 wherein:
the portion of the second plurality of destinations comprises:
each one of the second plurality of destinations within the maximum distance from the first one of the first plurality of destinations.

43. The method of claim 41 wherein:
the portion of the second plurality of destinations comprises:
at least one of the second plurality of destinations within the maximum distance from the first one of the first plurality of destinations.

44. The method of claim 43 wherein:
transmitting information regarding only a portion of the second plurality of destinations comprises:
transmitting information regarding less than all of the second plurality of destinations within the maximum distance from the first one of the first plurality of destinations.

45. The method of claim 41 wherein:
receiving the fourth selection comprises:
receiving an identification of a hotel.

46. The method of claim 45 wherein:
transmitting information regarding the fourth selection comprises:
transmitting information selected from the group consisting of: a name of the hotel; an address of the hotel; a description of the hotel; available rooms at the hotel; a description of the available rooms; a number of occupants allowed in each of the available rooms; rules of the hotel; and a price for each of the available rooms.

47. The method of claim 46 wherein:
the available rooms are selected by a person associated with the hotel.

48. The method of claim 47 further comprising:
alerting the person associated with the hotel when a number of the available rooms decreases below a pre-determined level.

49. The method of claim 31 wherein:
receiving the third selection comprises:
receiving an identification of one of the available rooms.

50. The method of claim 49 wherein:
transmitting information regarding the third selection comprises:
transmitting information selected from the group consisting of: a name of a hotel; a cost per night at the hotel for the one of the available rooms; and a description of the one of the available rooms.

51. The method of claim 31 further comprising:
allowing a first person affiliated with one of the first plurality of destinations or the second plurality of destinations to change an appearance of a portion of the web site related to the one of the first plurality of destinations or the second plurality of destinations with which the first person is associated.

52. The method of claim 51 further comprising:
allowing a second person affiliated with an intermediary to change an appearance of a portion of the web site.

53. The method of claim 52 wherein:
a user transmits the first, second, third, fourth, and fifth selections to the intermediary; and
receiving the first selection comprises receiving the first selection from the intermediary.

54. The method of claim 31 further comprising:
transmitting information regarding a user making the first, second, third, fourth, and fifth selections to at least one of the first and second pluralities of destinations.

55. A method of facilitating a purchase over a global information network, the method comprising:
receiving information regarding a first inventory via the global information network from a first plurality of destinations;
receiving information regarding a second inventory via the global information network from a second plurality of destinations;
providing information regarding the first plurality of destinations on a web site;
providing information regarding the second plurality of destinations on the web site;
providing information regarding the first inventory on the web site;
providing information regarding the second inventory on the web site;
receiving a first selection regarding a first one of the first plurality of destinations via the global information network from a user;
in response to the first selection, transmitting information regarding the first selection via the global information network to the user;
after transmitting the information regarding the first selection, receiving a second selection regarding the first inventory via the global information network from the user;
in response to the second selection, transmitting information regarding the second selection via the global information network to the user;
after transmitting the information regarding the second selection, receiving a third selection regarding a maximum distance between the first one of the first plurality of destinations and each one of the second plurality of destinations via the global information network from the user;
based on the third selection, transmitting information regarding only a portion of the second plurality of destinations via the global information network to the user;
after transmitting the information regarding the portion of the second plurality of destinations, receiving a fourth selection regarding a first one of the portion of the second plurality of destinations via the global information network from the user;
in response to the fourth selection, transmitting information regarding the fourth selection via the global information network to the user;
after transmitting the information regarding the fourth selection, receiving a fifth selection regarding the second inventory via the global information network, from the user;
in response to the fifth,selection,.transmnittincg information regarding the fifth selection via the global information network to the user; and
permitting the user to simultaneously purchase reservations for the first and second pluralities of destinations based on the first, second, third, fourth, and fifth selections.

56. The method of claim 55 wherein:
each one of the first plurality of destinations is a golf course;
the first inventory comprises a plurality of available tee times at the first plurality of destinations; and
each one of the plurality of available tee times at a particular golf course is selected by a person associated with the particular golf course.

57. The method of claim 56 further comprising:
transmitting information regarding at least one potential tee time at the particular golf course via the global information network to the person associated with the particular golf course.

58. The method of claim 57 further comprising:
alerting the person associated with the particular golf course when a number of the plurality of available tee times at the particular golf course decreases below a pre-determined level.

59. The method of claim 58 wherein:
each one of the second plurality of destinations is a hotel;
the second inventory comprises a plurality of available rooms at the second plurality of destinations; and
each one of the plurality of available rooms at a particular hotel is selected by a person associated with the particular hotel.

60. The method of claim 59 further comprising:
alerting the person associated with the particular hotel when a number of the available rooms at the particular hotel decreases below a pre-determined level.
